(19) United States
(12) Patent Application Publication
(10) Pub. No.: US 2010/0113289 A1
(43) Pub. Date: May 6, 2010

(54) Method and system for non-competitive copy number determination by genomic hybridization DGH

(75) Inventors: Andrew Craig, Letchworth Garden City (GB); Anthony Peter Colin Brown, Cambridge (GB); Nicholas Matthew Haan, Cambridge (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: BLUEGNOME LIMITED, Cambridge (GB)

(21) Appl. No.: 12/609,156

(22) Filed: Oct. 30, 2009

Related U.S. Application Data
(60) Provisional application No. 61/197,809, filed on Oct. 30, 2008.

(51) Int. Cl. C40B 30/00; C40B 60/12

(52) U.S. Cl. 506/7; 506/39

(57) ABSTRACT

A method and system for determining a copy number of one or more nucleic acid sequences in a test sample are provided. A solid surface with a plurality of probe sets labeled with a first detectable label material bound to the solid surface is provided. The labeled probes are contacted with one or more nucleic acid molecules of the test sample, under conditions suitable for hybridization, so as to form a modified solid surface. The one or more nucleic acid molecules is/are labeled with a second detectable label material. The modified solid surface is scanned to obtain first and second data, which is then mathematically transformed so as to determine the copy number of one or more nucleic acid sequences in the test sample relative to the copy number of the one or more different nucleic acid sequences in the test sample or a reference genome.

### RELATED APPLICATION

This application claims the benefit of U.S. Provisional Patent Application No. 61/197,809 filed on Oct. 30, 2008. U.S. Patent Application No. 61/197,809 is incorporated herein by reference in its entirety.

### BACKGROUND

Comparative genomic hybridization (CGH), first reported by Kallioniemi et al. in 1992 (Kallioniemi, A., et al., 1992, Science, 258, 818-821), is a technique that has been employed to detect the presence and identify the location of amplified or deleted sequences in genomic DNA, corresponding to so-called changes in copy number. Typically, genomic DNA is isolated from normal reference cells, as well as from test cells. The two nucleic acids are differentially labeled and then hybridized in situ to metaphase chromosomes of a reference cell. The repetitive sequences in both the reference and test DNAs are either removed or their hybridization capacity is reduced by some means. Chromosomal regions in the test cells which are at increased or decreased copy number can be identified by detecting regions where the ratio of signal from the two DNAs is altered. The detection of such regions of copy number change can be of particular importance in the diagnosis of genetic disorders.

Pinkel et al. in 1998 and 2003 disclosed the technique which has become widely known as array comparative genomic hybridization (also chromosomal microarray analysis, and hereafter in this application as arrayCGH). In 1998, Solinas-Toldo et al. described a similar “Matrix-based comparative genomic hybridization” approach (Solinas-Toldo. S, et al., 1997, Genes Chromosomes Cancer 20, 399-407).

The arrayCGH technique relies on similar assay principles to CGH with regard to exploiting the binding specificity of double stranded DNA. The major innovation of arrayCGH is to replace the metaphase chromosomes of a reference cell with a collection of potentially thousands of solid support bound unlabelled target nucleic acids (probes) e.g., an array of cDNAs which have been mapped to chromosomal locations. ArrayCGH is thus a class of comparative techniques for the high throughput detection of differences in copy number between two DNA samples. It has advantages over CGH in that it allows greater resolution to be achieved and has application to the detection and diagnosis of genetic disorders induced by a change in copy number, in addition to other areas where copy number detection is important. While the particulars vary, a range of different probe lengths may be used, including those encountered in oligonucleotide, PAC, and BAC sequences. These different technology platforms were reviewed by Albertson and Pinkel in 2003 and 2005 (Donna G. Albertson and Daniel Pinkel, 2003, Human Molecular Genetics, Vol. 12, Review Issue 2 R145-R152; Pinkel, D., et al., 2005, Annu Rev Genomics Hum Genet, 6, 331-354).

Array CGH is currently being used to support the efforts of clinicians in the investigation of genomic imbalance in constitutional cytogenetics and increasingly in oncology. These applications are incredibly demanding such that the microarrays designed for these applications must be produced to far more rigorous standards than those used in academic or pre-clinical research applications.

A number of technological advancements have been made in order to enhance the two color or two sample microarray strategy. Hessner 2004 (U.S. Patent Application Publication No. 2005-0014147), described the manufacture of “three color” microarrays where fluorescent materiel is co-spotted with the probe material during array manufacture. This co-spotted material is then detected in a third channel. While this approach enables the spotted material to be directly visualized for non destructive assessment of spot morphology it has limited additional utility over a simple measure of spot area for improving the calibration of hybridization data.

Ferea et al. 2004 (United States Patent Application Publication No. 2005-0239104) described the use of a series of control features which might be included on a microarray. This includes various positive and negative controls as well as features to measure spatial bias, in a microarray image. However none of the measure proposed are able to fully control for variations in the manufacturing or hybridization of arrays.

Conventionally, array CGH is a comparative technique and requires two samples. A typical experimental question is to determine whether a test sample contains any detectable genetic aberrations. The “test” sample is therefore compared to a “reference” sample known to have a normal copy number. Prior to using this technique, both samples must be prepared and fluorescently labeled. In practice, the same reference sample may often be used to perform a very large number of experiments. The need to repeatedly prepare and label the same reference sample is expensive and time consuming. Furthermore, the accuracy of the test relies on the reference sample being representative of normal genomic content. Should the reference sample itself contain copy number changes (for example polymorphisms), the accuracy of the test may be compromised.

Accordingly there is a need for highly accurate, lower cost, faster genomic copy number testing which requires fewer reagents and eliminates the reliance on the quality of the DNA reference sample.

### SUMMARY

Disclosed herein are embodiments of a method and system for non-competitive copy number determination by genomic hybridization array-DGH. In a first aspect, an exemplary embodiment may be arranged as a method for determining a respective copy number of one or more nucleic acid sequences in a test sample relative to a respective copy number of one or more different nucleic acid sequences in the test sample or of a reference genome, the test sample including one or more nucleic acid molecules, the method comprising:

(a) providing a solid surface including a plurality of labeled probe sets bound to the solid surface, wherein each of the labeled probe sets includes one or more probes labeled with a first detectable label material, and wherein each probe is representative of a nucleic acid sequence;

(b) contacting the labeled probes on the solid surface with the one or more nucleic acid molecules of the test sample, under conditions suitable for hybridizing the one or more nucleic acid molecules of the test sample to the labeled probes, so as to form a modified solid surface, wherein each of the one or more nucleic acid molecules of the test sample is labeled with a second detectable label material;

(c) scanning the modified solid surface to detect the first detectable label material and to thereafter generate first data associated with each labeled probe set, wherein the first data associated with each labeled probe set is indicative of a quantity of labeled probes of that labeled probe set;

(d) scanning the modified solid surface to detect the second detectable label material and to thereafter generate second data associated with each labeled probe set, wherein the second data associated with each labeled probe set is indicative of a quantity of one or more nucleic acid sequences in the nucleic acid molecules of the test sample; and

(e) mathematically transforming the first data and the second data so as to determine the copy number of one or more nucleic acid sequences in the test sample relative to the copy number of the one or more different nucleic acid sequences in the test sample or the reference genome.

In another aspect, an exemplary embodiment may be arranged as a system to determine a respective copy number of one or more nucleic acid sequences in a test sample relative to a respective copy number of one or more different nucleic acid sequences in the test sample or of a reference genome, the test sample including one or more nucleic acid molecules, the system comprising:

(a) a scanner to:
(i) scan a modified solid surface to detect a first detectable label material and to thereafter generate first data associated with each labeled probe set of a plurality of labeled probe sets bound to the modified solid surface,
wherein each of the labeled probe sets includes one or more probes labeled with the first detectable label material,
wherein each probe is representative of a nucleic acid sequence, and
wherein the first data associated with each labeled probe set is indicative of a quantity of labeled probes of that labeled probe set, and
(ii) scan the modified solid surface to detect a second detectable label material and to thereafter generate second data associated with each labeled probe set,
wherein each of the one or more nucleic acid molecules of the test sample is labeled with the second detectable label material,
wherein the second data associated with each labeled probe set is indicative of a quantity of one or more nucleic acid sequences in the nucleic acid molecules of the test sample, and
wherein formation of the modified solid surface includes contacting the one or more labeled probes with the one or more nucleic acid molecules of the test sample under conditions suitable for hybridizing the one or more nucleic acid molecules of the test sample to the labeled probes,

(b) a processor; and

(c) data storage containing computer-readable program instructions executable by the processor, wherein the program instructions include instructions executable by the processor to mathematically transform the first data and the second data so as to determine the copy number of one or more nucleic acid sequences in the test sample relative to the copy number of the one or more different nucleic acid sequences in the test sample or the reference genome.

The exemplary embodiments overcome the problems associated with using a single labeled sample by introducing an internal standard signal for each probe or probe set on the array. The internal standard signal controls for some of the variations in the manufacturing process and allows the single channel intensity data to be calibrated so as to give estimates of copy number in the test sample relative to a reference genome. Sources of bias in the system, some of which may also be present in existing two channel approaches, can then be corrected via the use of intelligent algorithms embodied as computer-readable program instructions.

The advantages of the exemplary embodiments include halving the number of labeled DNA samples an end-user must prepare and reducing costs through reduced reagent requirements and reduced labor in sample preparation. Furthermore, the exemplary embodiments eliminate the reliance on the quality of the DNA reference sample and further minimize the potential to make mistakes when pairing test and reference samples in the analytical protocol. The algorithmic enhancements described further improve the quality and interpretability of single channel data so that it is comparable to standard two channel approaches.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF FIGURES

Exemplary embodiments of the invention are described herein with reference to the drawings in which:

FIG. 1 is a block diagram of a system in which an exemplary embodiment may be implemented;

FIG. 2 is a schematic diagram depicting exemplary functions that may be carried out in providing a solid surface that includes a plurality of labeled probes bound to the solid surface;

FIG. 3 is a schematic diagram depicting functions that may be carried out in modifying a solid surface including a plurality of labeled probes bound to the solid surface;

FIG. 4 is a schematic diagram depicting functions that may be carried out in processing signals derived from analyzing a single test sample on an array including internal standards from a reference genome;

FIG. 5 depicts graphs illustrating exemplary data obtained during a naive single channel experiment that consists of obtaining signals for a single test sample from an array that does not include internal control signals; and

FIG. 6 depicts graphs illustrating exemplary data obtained during a single channel experiment that consists of obtaining signals for a single test sample from an array that includes an internal standard.

### DETAILED DESCRIPTION

### 1. Overview

The exemplary embodiments described herein include methods and systems for determining a respective copy number of one or more nucleic acid sequences in a test sample relative to a respective copy number of one or more different nucleic acid sequences in the test sample or of a reference genome. The test sample may include one or more nucleic acid molecules.

An exemplary embodiment arranged as a method for determining the copy number includes:

(i) providing a solid surface including a plurality of labeled probe sets bound to the solid surface, wherein each of the labeled probe sets includes one or more probes labeled with a first detectable label material, and wherein each probe is representative of a nucleic acid sequence,

(ii) contacting the labeled probes on the solid surface with the one or more nucleic acid molecules of the test sample, under conditions suitable for hybridizing the one or more nucleic acid molecules of the test sample to the labeled probes, so as to form a modified solid surface, wherein each of the one or more nucleic acid molecules of the test sample is labeled with a second detectable label material,

(iii) scanning the modified solid surface to detect the first detectable label material and to thereafter generate first data associated with each labeled probe set, wherein the first data associated with each labeled probe set is indicative of a quantity of labeled probes of that labeled probe set,

(iv) scanning the modified solid surface to detect the second detectable label material and to thereafter generate second data associated with each labeled probe set, wherein the second data associated with each labeled probe set is indicative of a quantity of one or more nucleic acid sequences in the nucleic acid molecules of the test sample, and

(v) mathematically transforming the first data and the second data so as to determine the copy number of one or more nucleic acid sequences in the test sample relative to the copy number of the one or more different nucleic acid sequences in the test sample or the reference genome.

### 2. Definitions

When the term “about” is used in describing a value or an end-point of a range, the invention should be understood to include the specific value or end-point referred to.

As used herein, the teens “comprises,” “comprising,” “includes,” “including,” “has,” “having” or an other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the invention. This description should be read to include one or at least one and the singular also includes the plural unless it is obvious that it is meant otherwise.

The word “exemplary” is used herein to mean “serving as an example, instance, or illustration.” Any embodiment described herein as “exemplary” is not necessarily to be construed as preferred or advantageous over other embodiments.

As used herein “copy number” is the number of copies of a particular gene or nucleic acid molecule of interest in a genotype corresponding to amplified or deleted sequences of genetic material.

As used herein “nucleic acid molecules” are any and all forms of alternative nucleic acid containing modified bases, sugars, and backbones. These include, but are not limited to DNA, RNA, aptamers, peptide nucleic acids (“PNA”), 2′-5′ DNA (a synthetic material with a shortened backbone that has a base-spacing that matches the A conformation of DNA; 2′-5′ DNA will not normally hybridize with DNA in the B form, but it will hybridize readily with RNA), locked nucleic acids (“LNA”), and nucleic acid analogues which include known analogues of natural nucleotides which have similar or improved binding properties. “Analogous” forms of purines and pyrimidines are well known in the art, and include, but are not limited to aziridinylcytosine, 4-acetylcytosine, 5-fluorouracil, 5-bromouracil, 5-carboxymethylaminomethyl-2-thiouracil, 5-carboxymethylaminomethyluracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7-methylguanine, 5-methylaminomethyluracil, 5-methoxyaminomethyl-2-thiouracil, beta-D-mannosylqueosine, 5-methoxyuracil, 2-methylthio-N-6-isopentenyladenine, uracil-5-oxyacetic acid methylester, pseudouracil, queosine, 2-thiocytosine, 5-methyl-2-thiouracil, 2-thiouracil, 4-thiouracil, 5-methyluracil, uracil-5-oxyacetic acid, and 2,6-diaminopurine. DNA backbone analogues provided by the invention include phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs), methylphosphonate linkages or alternating methylphosphonate and phosphodiester linkages, and benzylphosphonate linkages.

The “test sample” may be any suitable sample that can be tested using the exemplary systems and methods, including but not limited to body fluid samples including but not limited to, for example, plasma, serum, spinal fluid, semen, lymph fluid, tears, saliva, breast milk, and blood. The test sample can thus be derived from patient samples for use in, for example, clinical diagnostics, clinical prognostics, and assessment of an ongoing course of therapeutic treatment on an analyte in a test sample derived from the patient. Further uses include, but are not limited to, drug discovery, biomarker discovery, and basic research use.

As used herein “reference genome”, “reference collection”, or “reference sample” is the genomic material for which the copy number of the genes or nucleic acid molecules of interest are already known and thus serve as the control and provide an internal standard signal corresponding to the “first data.” The “reference genome”, “reference collection”, or “reference sample” is a mixture of one or more nucleic acid sequences derived from one or more sources of (i) synthetic oligonucleotides, (ii) cloned DNA, or (iii) genomic DNA harvested from biological tissue(s) and is not limited to samples from normal sources but can include samples from various disease states which can then serve as the control.

The “solid surface” can be any surface suitable for array CGH including both flexible and rigid surfaces. Flexible surfaces can include, but are not limited to, nylon membranes. Rigid surfaces include, but are not limited to, glass slides. The solid surface can further comprise a three dimensional matrix or a plurality of beads.

The solid surface includes a plurality (i.e., two or more) of labeled probe sets bound to the solid surface. Each “probe set” can comprise or consist of one or more of the same or different probes. The “modified solid surface” is formed by the hybridization of the one or more nucleic acid molecules from the test samples to the labeled probes of the labeled probes sets.

The “probes” can comprise or consist of any molecular entity suitable for binding a nucleic acid molecule, including but not limited to nucleic acids, polypeptides, organic compounds (including but not limited to ionophores), inorganic compounds, polysaccharides, lipids, or the active fragments or subunits or single strands of the preceding molecules. In various embodiments, the probes comprise synthetic oligonucleotides or are derived from cloned DNA. In preferred embodiments the oligonucleotides can be synthesized in situ or synthesized and then arrayed ex situ. In further preferred embodiments, the cloned DNA can be bacterial artificial chromosome (BAC) clones or P1-derived artificial chromosomes (PAC).

The plurality of labeled probe sets bound to the solid surface may be a plurality of the same probe sets, a plurality of different probe sets, or a combination of the two. For example, in embodiments where it is desired to multiplex the detection assay (i.e., detect more than one nucleic acid molecule at a time), a plurality of different probe sets that bind to different nucleic acid molecules can be used. In accordance with this example, the probe sets may be organized in predefined locations on the solid surface and the solid surface takes the form of an array or microarray with discrete locations for each of the probe sets.

In various embodiments the probes sets may comprise a negative control and/or a positive control. A negative control is a probe set to which no nucleic acid molecules will bind. A positive control is a probe set to which any non-specific nucleic acid molecules will bind. The probe sets may also comprise a series of serial dilutions of the labeled probes for calibration or correction of bias of the first data and second data associated with each labeled probe set. For example, a series of serial dilutions could be used to correct the ratio of the first and second data (or various corrected versions thereof) such that ratios where the labeled probe set concentration is low are corrected more than ratios associated with higher labeled probe set concentrations. Such a correction would be useful when the response of the measuring device to the quantity of labeled probe set is nonlinear. As an example, in a case in which the ratio data comprises log ratio data, the bias may be determined and removed from the log ratio data by fitting a smooth nonlinear function which maps the intensity content of each probe to its corresponding log ratio.

The probes in the probes sets are bound on the solid surface; such binding can be via any suitable covalent or non-covalent binding, including but not limited to, hydrogen bonding, ionic bonding, hydrophobic interactions, Van der Waals forces, and dipole-dipole bonds, including both direct and indirect binding. In a preferred embodiment, the solid surface may comprise a glass slide or a three-dimensional matrix. In accordance with this embodiment, the probe sets may be contact printed onto the glass slide or the three dimensional matrix. In a different preferred embodiment, the labeled probe of each labeled probe set is separately immobilized on a respective individual surface (e.g., a defined location or defined locations) of the solid surface. In accordance with this embodiment, each individual surface may include a plurality of beads.

The probes in the probe sets are labeled with a “first detectable label material.” The “detectable label material” can be any label material suitable for use in the exemplary embodiments, including but not limited to, radioactive labels such as ³²P, ³H, and ¹⁴C; fluorescent dyes such as fluorescein isothiocyanate (FITC), rhodamine, lanthanide phosphors, Texas red, and ALEXIS™ (Abbott Labs), CY™ dyes (Amersham); electron-dense reagents such as gold; enzymes such as horseradish peroxidase, beta-galactosidase, luciferase, and alkaline phosphatase; colorimetric labels such as colloidal gold; magnetic labels such as those sold under the mark DYNABEADS™; biotin; dioxigenin; or haptens and proteins for which antisera or monoclonal antibodies are available. The detectable label material may be coupled to the probes by any means known to those of skill in the art and can be coupled reversibly or irreversibly. The detectable label material can be directly attached to the probe, or it can be attached to a molecule which hybridizes or binds to the probe (i.e., indirectly attached).

In a preferred embodiment, a plurality of nucleic acid molecules from a reference sample containing a known copy number of the genes of interest, are labeled with the first detectable label. The labeled nucleic acid molecules from the reference sample are then hybridized to the probes on the solid surface, resulting in a detectable label on the probes. The hybridizing of the nucleic acid molecules from the reference sample, to the probe can be reversible or irreversible. Irreversible hybridization may be achieved by cross linking the probe DNA and internal standard DNA using an alkylating agent or any similar chemical or physical process for introducing covalent bonds between DNA strands. The precise method used for cross linking the nucleic acid molecules from the reference sample to the probes is not crucial to carrying out the exemplary embodiments.

In the exemplary embodiments described herein, the nucleic acid molecules from the reference sample can comprise synthetic oligonucleotides and the copy number can be perturbed by flow sorting or by adding genomic DNA.

The term “contacting” the labeled probes with one or more nucleic acid molecules of the test sample can be by any suitable means, including placement of a liquid test sample on the solid surface.

The term “conditions suitable for hybridizing” as used herein refer to the binding, duplexing, or hybridizing of a nucleic acid molecule preferentially to a particular probe sequence under moderate or stringent conditions. The term “stringent conditions” refers to conditions under which one nucleic acid will hybridize preferentially to second sequence (e.g., a sample genomic nucleic acid hybridizing to an immobilized nucleic acid probe in an array), and to a lesser extent to, or not at all to, other sequences. A “stringent hybridization” and “stringent hybridization wash conditions” in the context of nucleic acid hybridization (e.g., as in array, Southern or Northern hybridizations) are sequence dependent, and are different under different environmental parameters. Stringent hybridization conditions as used herein can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Those of ordinary skill will readily recognize that alternative but comparable hybridization and wash conditions can be utilized to provide conditions of similar stringency.

However, the selection of a hybridization format is not critical, as is known in the art, it is the stringency of the wash conditions that set forth the conditions which determine whether a soluble, sample nucleic acid will specifically hybridize to an immobilized probe sequence. Wash conditions can include, e.g., a salt concentration of about 0.02 molar at pH 7 and a temperature of at least about 50° C. or about 55° C. to about 60° C.; or, a salt concentration of about 0.15 M NaCl and a temperature of at least about 72° C. for at least about 15 minutes; or, a salt concentration of about 0.2×SSC at a temperature of at least about 50° C. or about 55° C. to about 60° C. for at least about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

An exemplary “moderate stringency” wash comprises 1×SSC at 45° C. for 15 minutes.

An extensive guide to the hybridization of nucleic acids is found in, e.g., Sambrook Ausubel, Tijssen. Stringent hybridization and wash conditions can be selected to be about 5° C. lower than the thermal melting point (Tₘ) for the specific sequence at a defined ionic strength and pH. The Tₘ is the temperature (under defined ionic strength and pH) at which 50% of the target sequence hybridizes to a perfectly matched probe. Very stringent conditions are selected to be equal to the Tₘ for a particular probe.

The nucleic acid molecules of the test sample are labeled with a “second detectable label material.” The “detectable label material” can be any label material suitable for use in the exemplary embodiments described herein. The “second” detectable label material can be the same detectable label material as the “first detectable label material” or they can be different. As an example, the first detectable label material and the second detectable label material may be the same fluorescent dye, such as CY3. As another example, the first detectable label material and the second detectable label material may be different fluorescent dyes, such as CY3 and CY5, respectively. Other examples of the first and second detectable label materials are also possible.

In the embodiments in which the first and second detectable label materials are the same, the labels can be detectable in a single channel. In the embodiment in which the first and second detectable label materials are different, the labels can be detectable in different channels.

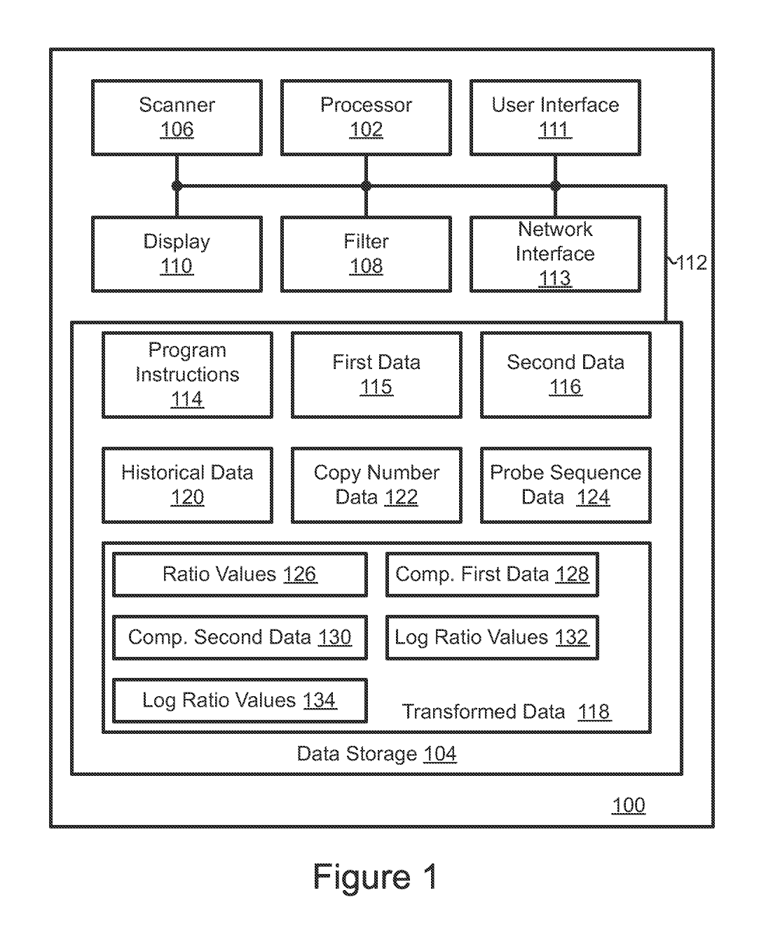

As used herein “scanning” refers to a method carried out by a scanner (e.g., scanner 106 shown in FIG. 1) to detect a detectable label material. By way of example, the method carried out by the scanner may include emitting light from a light source of the scanner and, at a detector of the scanner, receiving the emitted light that reflects off of a respective location of the modified solid surface.

“Location of the modified solid surface” refers to an area of the modified solid surface from which light emitted from the scanner light source is reflected and received at the scanner detector.

“First data” comprises data that is generated by scanning the modified solid surface so as to detect the first detectable label material. The first data may include data for each defined location on the modified solid surface. Each labeled probe set is located at a respective defined location or locations on the modified solid surface. In particular, for each defined location of the modified solid surface, the first data may represent the intensity of the first detectable label material at the defined location while the first detectable label material at that location is being excited by a first laser of an exemplary scanner 106. “First data” may be maintained in data storage as first data 115, as shown in FIG. 1. First data 115 may comprise a plurality of data values for each labeled probe set of the modified solid surface.

“Second data” comprises data that is generated by scanning the modified solid surface so as to detect the second detectable label material. The second data may include data for each defined location on the modified solid surface. In particular, for each defined location of the modified solid surface, the second data may represent the intensity of the second detectable label material at the defined location while the second detectable label material at that location is being excited by a second laser of an exemplary scanner 106. “Second data” may be maintained in data storage as second data 116, as shown in FIG. 1. Second data 116 may comprise a plurality of data values for each labeled probe set of the modified solid surface.

The exemplary embodiments described herein can be used to diagnose diseases or disorders associated with changes in gene copy number.

### 3. Exemplary Architecture

Next, FIG. 1 depicts a system 100 in which exemplary embodiments described herein may be carried out. It should be understood, however, that this and other arrangements described herein are provided for purposes of example only. As such, those skilled in the art will appreciate that other arrangements and other elements (e.g. machines, interfaces, functions, orders, and groupings of functions, etc.) can be used instead, and some elements may be omitted altogether. Further, many of the elements described herein are functional entities that may be implemented as discrete or distributed components or in conjunction with other components, in any suitable combination and location, and as any suitable combination of hardware, firmware, and/or software. Additionally or alternatively, a computer-readable medium may contain program instructions, executable by a processor, to cause functions described herein to be performed.

As illustrated in FIG. 1, system 100 includes a processor 102, data storage 104, a scanner 106, a filter 108, a display 110, a user interface 111, and a network interface 113, all of which may be linked together via a system bus, network, or other connection mechanism 112.

Processor 102 may comprise one or more general purpose processors (e.g., one or more INTEL microprocessors) and/or one or more special purpose processors (e.g., one or more digital signal processors). Processor 102 may execute computer-readable program instructions 114 contained in data storage 104.

Data storage 104 comprises a computer-readable storage medium readable by processor 102. The computer-readable storage medium may comprise volatile and/or non-volatile storage components, such as optical, magnetic, organic or other memory or disc storage, which can be integrated in whole or in part with processor 102.

Data storage 104 may contain a variety of data such as computer-readable program instructions 114, first data 115, second data 116, transformed data 118, historical data 120, copy number data 122, and probe sequence data 124. As an example, the program instructions 114 may include instructions that are executable by processor 102 to mathematically transform first data 115 and/or second data 116 so as to determine a copy number of one or more nucleic acid sequences in a test sample relative to a copy number of one or more different nucleic acid sequences in the test sample or a reference genome. Examples of program instructions to transform first data 115 and/or second data 116 and the functions carried out by execution of such program instructions are described below.

Transformed data 118 may include a variety of data that is generated by execution of program instructions 114 to mathematically transform (e.g., modify) first data 115 and/or second data 116. Transformed data 118 may also include data that is generated by execution of program instructions to transform data that is currently stored as transformed data 118. As an example, transformed data 118 may include ratio values 126, compensated first data 128, compensated second data 130, and log ratio values 132, 134. Each of these examples of transformed data 118 is described below.

Historical data 120 may include a variety of data. Historical data 120 may comprise data that is determined by processor 102, received into system 100 via user interface 111, and/or received into system 100 via network interface 113. User interface 111 may include a QWERTY keyboard at which a user can type the historical data, and network interface 113 may include a network interface card (NIC) that connects to a network for transporting the historical data from another system, such as a system with a processor and data storage containing the historical data. Other example of user interface 111 and network interface 113 are also possible.

By way of example, historical data 120 may include historical log ratio values of the first data and the second data obtained via scanner 106 for one or more solid surfaces. In accordance with an embodiment in which historical data 120 include historical log ratios for a plurality of solid surfaces, historical data 120 may include average log ratio values. The average log ratio values of historical data 120 may be used as historical bias values to compensate log ratio values determined from first data 115 and second data 116 for a solid surface for which a user desires to determine a copy number.

Copy number data 122 may include one or more copy numbers as determined by processor 102. After determining a copy number, processor 102 may execute program instructions that cause the copy number to be stored as copy number data 122. As an example, copy number data 122 may include a respective copy number of each nucleic acid sequence in a test sample. As another example, copy number data 122 may include a copy number of the reference genome.

Probe sequence data 124 contains data for correcting sequence-related bias. As an example, guanine/cytosine (GC) content of a particular probe sequence can bias both its hybridization affinity and labeling potential. First data 115 and second data 116 may be affected by the sequence-related bias. The GC content bias may be determined (e.g., modelled) and removed from log ratio data by fitting a smooth nonlinear function which maps the GC content of each probe to its corresponding log ratio. As another example, probe sequence data 124 may indicate a fractional GC nucleotide base content of the one or more nucleic acid molecules of the test sample. As yet another example, probe sequence data 124 indicates a repetitive sequence content of the one or more nucleic acid molecules of the test sample.

Scanner 106 provides means for scanning (e.g., reading) a solid surface (e.g., the modified solid surface) so as to generate first data 115 and second data 116. Scanner 106 may be arranged in any of a variety of configurations. In an exemplary configuration, scanner 106 may include (i) a light source, (ii) at least one optical lens, and (iii) a light detector. The light source may comprise any of a variety of light sources, such as a plurality of light emitting diodes, a plurality of super-luminescent diodes, or a plurality of lasers. The light source may emit multiple wavelengths of light. For instance, a light source including a plurality of lasers may emit include a green laser for exciting the first detectable label material (e.g., CY3) and a red laser for exciting the second detectable label material (e.g., CY5). Alternatively, the light source (e.g., a single laser) may emit only one wavelength of light. Other examples of the light source are also possible.

In one respect, scanner 106 may be movable relative to the modified solid surface such that the light emitted by scanner 106 may be directed to any of a plurality of locations of the modified solid surface. In another respect, scanner 106 may be operable in a fixed position, such that the modified solid surface can be moved relative to scanner 106 such that the light emitted by the scanner 106 may be directed to any of the plurality of locations of the modified solid surface.

The light detector of scanner 106 is operable to receive emitted light that reflects off of the modified solid surface, and in particular, emitted light that reflects off of the labeled probe sets and/or the labeled nucleic acid molecules of the test sample. The light received at the light detector may pass through the at least one lens prior to being received at the light detector. The light detector may convert the received light into an electrical signal that, in turn, can be passed through an analog-to-digital converter (ADC) within system 100. Digital output values produced by the ADC may be stored as first data 115 and second data 116.

Filter 108 may comprise one or more filters. Filter 108 may comprise program instructions contained within program instructions 114. As an example, filter 108 may comprise (i) a one-dimensional or two-dimensional sliding window median smoother filter, (ii) a one-dimensional or two dimensional sliding window mean smoother filter, (iii) a one-dimensional or two-dimensional loess filter, (iv) a one-dimensional or two-dimensional spline filter, and/or (v) a one-dimensional or two-dimensional k-nearest neighbor smoother filter. Other examples of filter 108 are also possible.

Display 110 may comprise any of a variety of displays operable to display various types of data and or images. Display 110 may include a cathode ray tube (CRT) display, a plasma display, a liquid crystal display (LCD), an organic light emitting diode (OLED) display, or another type of display.

As an example, an image displayable by display 110 may include, but is not limited to, (i) an image of the first detectable label material, (e.g., a first image generated by scanning the modified solid surface), (ii) an image of the second detectable label material, (e.g., a second image generated by scanning the modified solid surface), (iii) an image that represents the image of the first detectable label material combined with the image of the second detectable label material, (iv) an image of a determined copy number of at least one nucleic acid sequences in a test sample, (v) an image of a determined copy number of at least one nucleic acid sequences in a test sample relative to the respective copy number of at least one different nucleic acid sequence in the test sample, and (vi) an image of a determined copy number of at least one nucleic acid sequence in a test sample relative to the respective copy number of at least one different nucleic acid sequence in the test sample or a reference genome. As another example, display 110 may display any of the images that are described elsewhere in this description.

### 4. Exemplary Operation

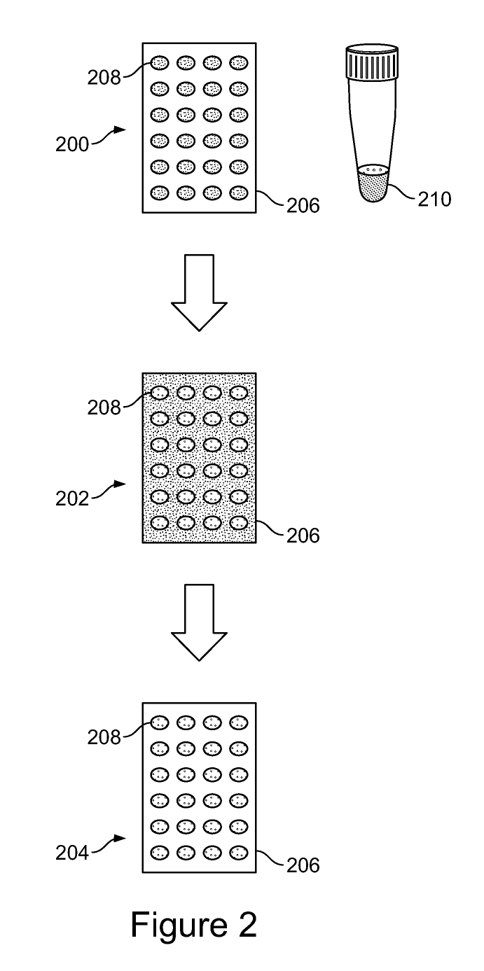

Next, FIG. 2 is a schematic diagram that illustrates functions for introducing internal standards into a microarray (e.g., a microarray on a glass slide). The microarray or slide can be scanned so as to produce a signal due to the internal standard. The signal is proportional to a quantity of probe material present in each probe feature (e.g., labeled probe set).

In particular, FIG. 2 illustrates functions 200, 202, 204 that may be carried out so as to provide a solid surface 206 that includes a plurality of labeled probe sets bound to solid surface 206. Performance of functions 200, 202, 204 may introduce an internal standard onto solid surface 206. First data 115 may represent the internal standard. Each oval-shaped element shown in FIG. 2 represents a respective labeled probe set, such as labeled probe set 208. In an exemplary embodiment, solid surface 206 takes the form of a microarray of different probes organized into discrete probe sets on solid surface 206.

Function 200 includes contact printing the probes onto solid surface 206. The probes may be derived from cloned human DNA in the form of BAC and PAC clones. The probes may be labeled indirectly with a reference sample 210, such as commercially obtained reference genomic DNA 210 containing a known copy number of the nucleic acids of interest. The nucleic acid molecules of reference sample 210 may be labelled with a fluorescent dye, such as CY3.

Next, function 202 includes hybridizing the labelled nucleic acid molecules of reference sample 210 onto the probes of solid surface 206 in order to quantitatively label the probe material on solid surface 206. After performance of the hybridization function 202, function 204 includes washing solid surface 206 in order to remove any non-specifically bound labelled reference nucleic acid molecules from solid surface 206. In one exemplary embodiment in which reference sample 210 includes a reference genome, solid surface 206 may then be scanned so as to generate first data 115 and to provide an internal standard signal corresponding to the copy number of the reference genome.

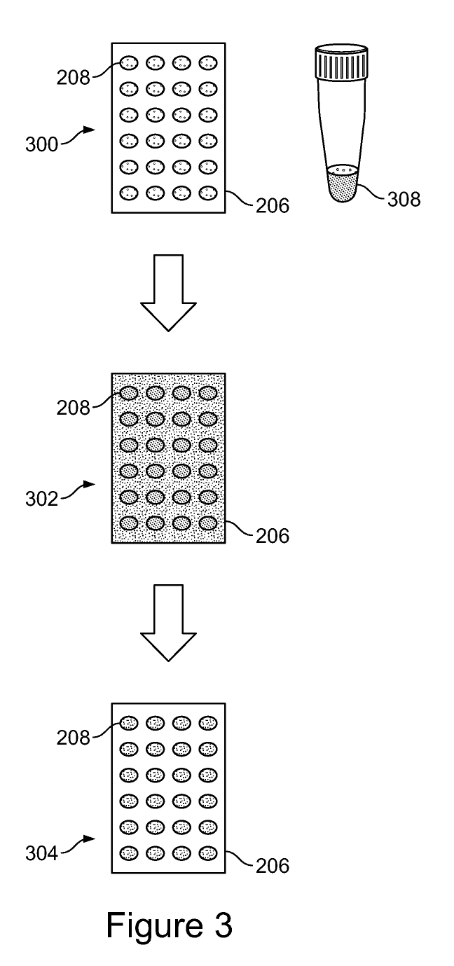

Next, FIG. 3 is a schematic diagram that illustrates functions that may be carried out to analyze a test sample using a microarray that incorporates internal standards. The microarray or slide can be scanned so as to produce a signal due to the combination of the test sample and the internal standard.

In particular, FIG. 3 illustrates functions 300, 302, 304 that may be carried out after performance of functions 200, 202, 204. At function 300, the nucleic acid molecules from a test sample 308 are labelled with the same dye (e.g. CY3) used to label the nucleic acid molecules from the reference sample 210. At function 302, the labelled nucleic acid molecules from the test sample 308 are hybridized onto the solid surface 206 produced, at least in part, via functions 200, 202, 204. At function 304, the solid surface 206 is then washed to remove any non-specifically bound labelled nucleic acid molecules from the test sample 308. Thereafter, the solid surface 206 is scanned again so as to generate second data 116 comprising the sum of signals due to the reference sample 210 and the test sample 308.

In this exemplary embodiment, the hybridizations of the nucleic acid molecules from the reference genome and the nucleic acid molecules from the test sample to the probes are optimised so as to achieve good data signals for each probe set without allowing the hybridization to approach too closely to thermodynamic equilibrium. This ensures that the hybridization kinetics remain approximately linear and that the additive signal due to the reference sample and test samples is quantitative. This requires knowledge of the kinetic and thermodynamic characteristics of the hybridization which can be obtained empirically.

These procedures result in a pair of signals in the form of images which must be analysed together in order to estimate the copy number of each of the nucleic acid molecules present in the test sample.

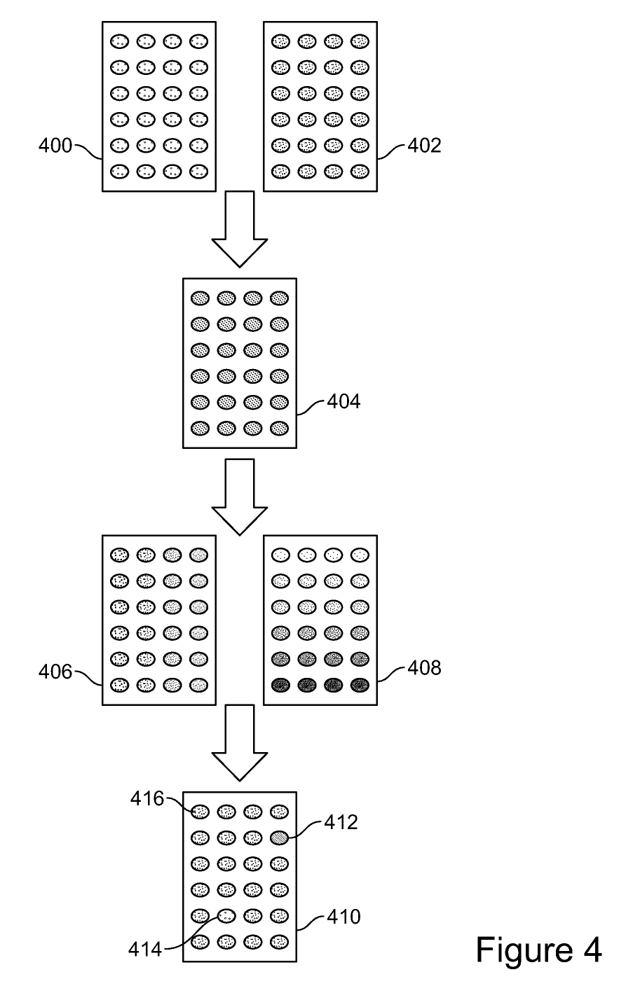

FIG. 4 is a schematic diagram that illustrates functions involved in processing the signals derived from analyzing a single test sample on an array (e.g., solid surface 206) including internal standards. A ratio of the signal due to the test sample and signal due to the internal standard can be obtained and related to a relative copy number of the test sample with respect to a normal reference genome. The functions illustrated in FIG. 4 include removing sources of bias which compromise interpretation of the data.

The top row of FIG. 4 illustrates images 400, 402 that can be produced after carrying out the functions of FIG. 2 and FIG. 3, respectively. For example, image 400 comprises an image of solid surface 206 that is produced after carrying out function 204 of FIG. 2, and image 402 comprises an image of solid surface 206 that is produced after carrying out function 304 of FIG. 3. Images 400, 402 may be stored as first data 115 and second data 116, respectively.

Although the patterns of each labeled probe set of image 400 are illustrated as being the same, a person having ordinary skill in the art will understand that a respective intensity of each labeled probe set of image 400 relative to the other labeled probe sets of image 400, as well as the intensity throughout one or more labeled probe sets of image 400, may vary in intensity. Such variation in intensity may arise due to diffusion that occurs when the reference is hybridized to solid surface 206.

Although the patterns of each labeled probe set of image 402 are illustrated as being the same, a person having ordinary skill in the art will understand that a respective intensity of each labeled probe set of image 402 relative to the other labeled probe sets of image 402, as well as the intensity throughout one or more labeled probe sets of image 402, may vary in intensity. Such variation in intensity may arise due to diffusion that occurs when the sample is hybridized to solid surface 206.

The second row of FIG. 4 illustrates that a pair of signals in the form of images 400, 402 may be aligned and represented as image 404. Although the patterns of each labeled probe set of image 404 are illustrated as being the same, a person having ordinary skill in the art will understand that a respective intensity of each labeled probe set of image 404 relative to the other labeled probe sets of image 404, as well as the intensity throughout one or more labeled probe sets of image 404, may vary in intensity. Such variation in intensity may arise due to diffusion that occurs when the reference and sample are hybridized to solid surface 206.

The third row of FIG. 4 illustrates the additive foreground spatial bias may be determined within images 400, 402. The additive foreground spatial bias of the labeled probe sets of images 400, 402 are illustrated in images 406, 408 respectively. By way of example, the additive foreground spatial bias of image 400 is shown in image 406 as increasing in intensity from the left side of image 406 towards the right side of image 406, whereas the additive foreground spatial bias of image 402 is shown in image 408 as increasing in intensity from the top of image 408 towards the bottom of image 408. A person having ordinary skill in the art will understand that the additive foreground spatial bias in an image representing the hybridized reference (internal standard) on the solid surface or an image representing the hybridized sample on the solid surface may comprise an image in which the intensity of the additive foreground spatial bias changes in any of a variety of ways other than those shown in images 406, 408.

Upon determining the additive foreground spatial bias, the log ratio between the test sample (represented by image 402) and the reference genome (represented by image 400) may be calculated. An example of determining this bias is described below.

The fourth row of FIG. 4 illustrates image 410. Image 410 represents modified log ratio data. As an example, the modified log ratio data of image 410 may comprise log ratio data in which the multiplicative foreground spatial bias is determined from the additive foreground spatial bias of images 406, 408 has been removed. As another example, the modified log ratio data of image 410 may comprise log ratio data in which GC sequence content bias has been removed. As yet another example, the modified log ratio data of image 410 may comprise log ratio data in which the multiplicative foreground spatial bias determined from the additive foreground spatial bias of images 406, 408 and GC sequence content bias has been removed. A person having ordinary skill in the art will understand that for each of the foregoing examples of modified log ratio data of image 410, other sources of bias may be detected and removed from the log ratio data so as to determine the modified log ratio data.

The modified log ratio data of image 410 comprises modified log ratio data for a plurality of labeled probe sets (i.e., the oval-shaped elements). In the example illustrated in FIG. 4, the labeled probe set 416 and the labeled probe sets having the same pattern as labeled probe set 416 each comprise a labeled probe set having a log ratio in which the copy numbers of the corresponding labeled probe sets of images 400, 402 are the same or substantially similar.

Further, in the example illustrated in FIG. 4, the labeled probe sets 412, 414 are shown as having respective patterns that differ from the pattern of the other labeled probe sets of image 410. The patterns of probe sets 412, 414 are used to illustrate that these probe sets have a brightness that is greater than or less than the other probe sets of image 410 and/or that the log ratio data of these probe sets is greater than or less than the expected log ratio for those probe sets, which is typically zero if the test and reference sample are expected to have the same copy number for the sequence targeted by a given probe set. In this regard, the labeled probe sets 412, 414 represent a genetic difference exists between the reference and sample that were applied to probe sets 412, 414.

In a different embodiment of the instant invention, using cloned DNA, the probes can be labelled by hybridizing an ensemble of fluorescently labelled oligonucleotides mixed in known proportions. The specific oligonucleotide sequences and their relative proportions are determined from an analysis of the sequence data of both the reference sample and expression systems used to grow the cloned DNA.

In this embodiment, the oligonucleotide sequences are chosen so as to give comprehensive coverage of the reference sample genome in the regions where the probe features occur while at the same time minimising cross hybridization to any foreign DNA present in the probe features which may arise from the expression system or cloning vector used to produce the cloned probe material. Furthermore the proportions of the different oligonucleotide sequences may be chosen so as to correspond to the copy numbers of those sequences in the reference sample genome. The solid surface is then scanned so as to generate the first data which is indicative of a quantity of labelled probes and provides an internal standard signal corresponding to the copy number for the reference sample genome.

Mathematical Transformation of the First Data and the Second Data

The mathematical transformation of first data 115 and/or second data 116 may be carried out by processor 102 executing program instructions 114. Execution of these program instructions may include processor 102 (i) reading first data 115, second data 116, transformed data 118, historical data 120, and/or probe sequence data 124, and (ii) generating transformed data 118 and/or copy number data 122. Execution of these program instructions may also include carrying out one or more additional functions described below.

In a first respect, mathematically transforming first data 115 and second data 116 may include (i) determining ratio values 126, and (ii) transforming ratio values 126 from a linear space to a log space. Each ratio value of ratio values 126 may be based on at least one data value of first data 115 and at least one data value of second data 116. The at least one data value of first data 115 and the at least one data value of second data 116 may correspond to a common location on the modified solid surface. Each ratio value of ratio values 126 may comprise a ratio value that has been transformed from a linear space to a log space by processor 102.

In a second respect, mathematically transforming first data 115 and second data 116 may include performing the functions A, B, C, and D, as described below. Functions A and B may be carried out simultaneously.

Function A includes compensating first data 115 for additive spatial bias so as to generate compensated first data 128 that is associated with each labeled probe set. Compensating first data 115 may include passing at least some of the data values (e.g., all of the data values) of first data 115 through filter 108, such as a 2-dimensional median smoothing filter or another type of filter. Processor 102 may cause compensated first data 128 to be stored within data storage 104.

Function B includes compensating second data 116 for additive spatial bias so as to generate compensated second data 130 that is associated with each labeled probe set. Compensating second data 116 may include passing at least some of the data values (e.g., all of the data values) of second data 116 through filter 108, such as a 2-dimensional median smoothing filter or another type of filter. Processor 102 may cause compensated second data 130 to be stored within data storage 104.

Function C includes determining a first plurality of log ratio values 132. Each log ratio value of the first plurality of log ratio values 132 is based on the compensated first data 128 and the compensated second data 130. In one case, each of the ratios values of log ratio values 132 may be based on the ratio first data 128 over second data 130. In another case, each of the ratios values of log ratio values 132 may be based on the ratio second data 130 over first data 128. In the latter case relative to the first case, the sign of the log ratio value would be changed from positive to negative or from negative to positive.

Function D includes determining a second plurality of log ratio values 134 by compensating the first plurality of log ratio values 132 for multiplicative spatial bias. Compensating the first plurality of log ratio values 132 may include passing at least some of the log ratio values (e.g., all of the log ratio values) of the first plurality of log ratio values 132 through filter 108, such as a 2-dimensional median smoothing filter or another type of filter.

In a third respect, mathematically transforming first data 115 and second data 116 may include using probe sequence data 124 to correct sequence-related bias.

In a fourth respect, mathematically transforming first data 115 and second data 116 may include performing one or more of the functions E, F, G, H, I, J, K, and L, as described below. Functions E, F, G, H, I, J, K, and L may be performed for each labeled probe set of the plurality of labeled probe sets of solid surface or the modified solid surface.

Function E includes, for each data value of a given first plurality of data values associated with a given labeled probe set, determining an additive spatial bias value and subtracting the additive spatial bias value from the data value so as to generate a compensated data value based on the data value of the given first plurality of data values. The given first plurality of data values may comprise all of the data values associated with the given labeled probe set and may be data values represented by first data 115. Determining the additive spatial bias value for each data value of the given first plurality of data values may include passing the given first plurality of data values through filter 108, such as a 2-dimensional median smoothing filter or another type of filter.

Function F includes, for each data value of a given second plurality of data values associated with the given labeled probe set, determining an additive spatial bias value and subtracting the additive spatial bias value from the data value so as to generate a compensated data value based on the data value of the given second plurality of data values. The given second plurality of data values may comprise all of the data values associated with the given labeled probe set and may be data values represented by second data 116. Determining the additive spatial bias value for each data value of the given second plurality of data values may include passing the given second plurality of data values through filter 108, such as a 2-dimensional median smoothing filter or another type of filter.

Function G includes maintaining third data that comprises each of the compensated data values based on a data value of given first plurality of data values. Processor 102 may execute program instructions that cause data storage 104 to store and thereafter maintain the third data as transformed data 118.

Function H includes maintaining fourth data that comprises each of the compensated data values based on a data value of the given second plurality of data values. Processor 102 may execute program instructions that cause data storage 104 to store and thereafter maintain the fourth data as transformed data 118.

Data storage 104 may maintain the third data and the fourth data, as well as the determined additive spatial bias values. Each data value of first data 115 may be associated with a respective data value of second data 116, a respective data value of the third data, and a respective data value of the fourth data. Each data value of first data 115, the respective data value of second data 116, the respective data value of the third data, and the respective data value of the fourth data may be associated with a respective location at the modified solid surface. Each data value of first data 115 may be indicative (or at least partly indicative) of the quantity of labeled probes bound to the modified solid surface location that is associated with the data value. Similarly, each data value of second data 116 may be indicative of (or at least partly indicative of) the quantity of labeled nucleic acid molecules of the test sample hybridized to the labeled probes bound to the modified solid surface location that is associated with the data value.

Function I includes determining a first plurality of log ratio values 132 based on a compensated data value of the third data (CDV3) and a corresponding compensated data value of the fourth data (CDV4). As an example, each log ratio value of the first plurality of log ratio values 132 is equal to log₂ (the CDV4 divided by the corresponding CDV3).

Function J includes determining a second plurality of log ratio values 134. Determining the second plurality of log ratio values 134 may include, for each log ratio value of the first plurality of log ratio values 132, (i) determining a multiplicative bias value associated the log ratio value, and (ii) subtracting the determined multiplicative bias value from the associated log ratio value so as to generate a log ratio value compensated for multiplicative bias. Determining the multiplicative bias value associated with the log ratio value, for each log ratio value of the first plurality of log ratio values, includes passing the first plurality of log ratio values through filter 108, such as a 2-dimensional median smoothing filter or another type of filter.

Function K includes determining a third plurality of log ratio values. Determining the third plurality of log ratio values may include, for each log ratio value of the second plurality of log ratio values 134, (i) determining a probe sequence bias value associated with the log ratio value, and (ii) subtracting the probe sequence bias value from the associated log ratio value so as to generate a log ratio value compensated for probe sequence bias (e.g., GC content bias). Determining each of the probe sequence bias values associated with the log ratio values includes passing the second plurality of log ratio values 134 through filter 108. In particular and by way of example, the second plurality of log ratio values 134 may be passed through a median filter or a one-dimensional sliding window median smoothing filter. The third plurality of log ratio values may be maintained as transformed data 118.

Function L includes determining a fourth plurality of log ratio values. Determining the fourth plurality of log ratio values may include, for each log ratio value of the third plurality of log ratio values determined via Function L, (i) determining a historical bias value associated with the log ratio value, and (ii) subtracting the historical bias value from the associated log ratio value so as to generate a log ratio value compensated for historical bias. As an example, determining the historical bias value may include determining an average log ratio value over a set of historical measurements. Each historical bias value may be associated with a reference genome. The fourth plurality of log ratio values may be maintained as transformed data 118.

### Example 3

In another embodiment of the invention, the probes may be produced using directly labelled oligonucleotide probes either synthesised in situ on the solid surface, or alternatively ex situ and subsequently printed onto the solid surface. Fluorescently labelled nucleotide triphosphates serve as the substrate for the oligonucleotide synthesis process. In this way the probes are directly and quantitatively labelled and bound to the solid surface. The solid surface is then scanned so as to generate first data 115 which is indicative of a quantity of labelled probes and provides an internal standard signal.

### Example 4

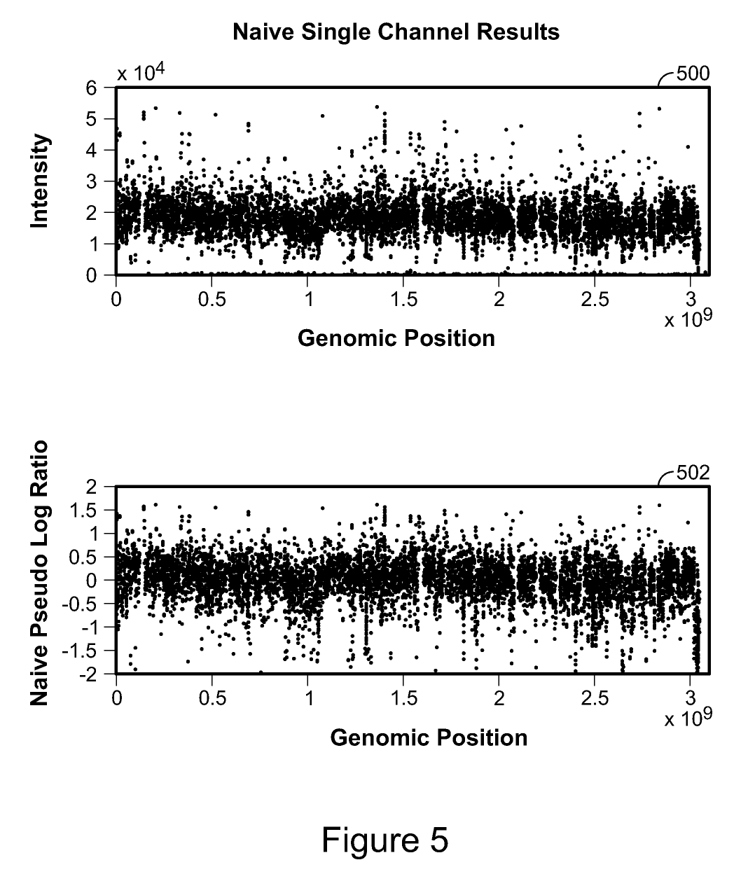

Next, FIG. 5 depicts an upper panel 500 and a lower panel 502 for a naive single channel experiment that includes obtaining signals for a single test sample from an array which does not include internal control signals. Upper panel 500 depicts an intensity of a probe features as a function of genomic location. Lower panel 502 depicts the same data of upper panel 500 except that the data has been normalized by a mean signal and log transformed. In both panels 500, 502, the presence of a slowly varying trend across the panel and the high variance about the expected log ratio.

### Example 5

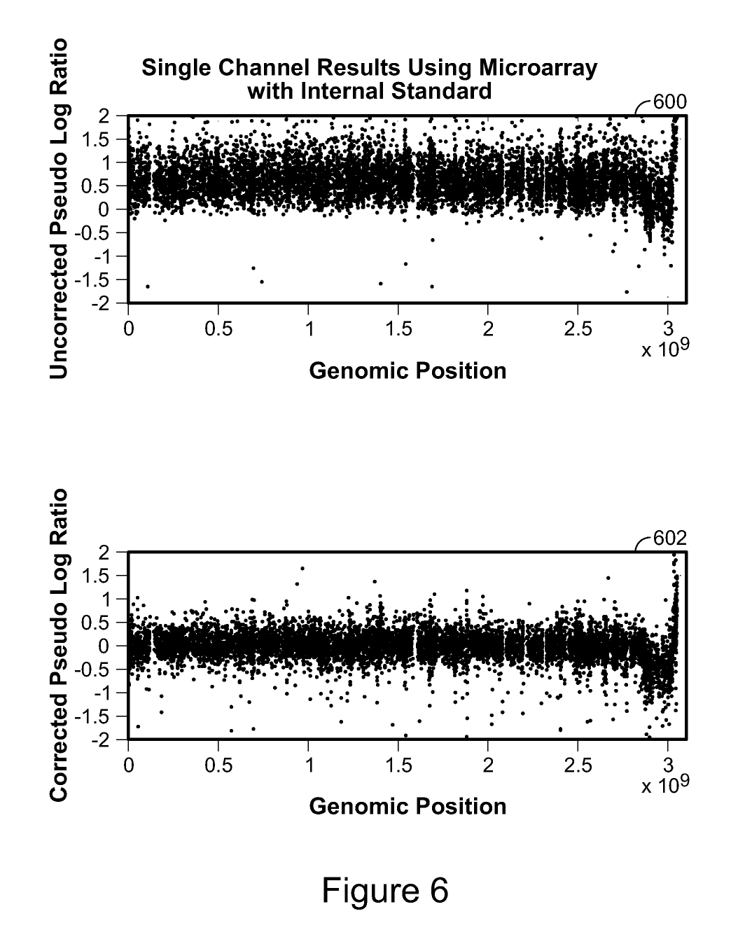

Next, FIG. 6 depicts an upper panel 600 and a lower panel 602 for a naive single channel experiment that includes obtaining signals for a single test sample from an array that includes an internal standard. In this example, the test sample was male genomic reference DNA and the internal standard was produced using female genomic reference DNA. Upper panel 600 depicts a pseudo log ratio estimate for the test sample, the log ratio being estimated without removal of any sources of bias. In upper panel 600, an offset in the pseudo log ratio is due to differences in the signal strength of the internal standard and the net test of an internal standard signal. Lower panel 602 depicts the same data of upper panel 600 except that the additive and multiplicative spatial bias and bias due to probe GC content have been removed. Removal of this bias normalizes the data so that the expected log ratio is substantially zero and the variance about the expected log ratio is reduced. The corrected profile of data shown in panel 602 is flatter than the naïve profiles of data shown in panels 500 and 502.

### Additional Example Embodiments

### Embodiment 1

A method for determining a respective copy number of one or more nucleic acid sequences in a test sample relative to a respective copy number of one or more different nucleic acid sequences in the test sample or of a reference genome, the test sample including one or more nucleic acid molecules, the method comprising:

(a) providing a solid surface including a plurality of labeled probe sets bound to the solid surface, wherein each of the labeled probe sets includes one or more probes labeled with a first detectable label material, and wherein each probe is representative of a nucleic acid sequence;

(b) contacting the labeled probes on the solid surface with the one or more nucleic acid molecules of the test sample, under conditions suitable for hybridizing the one or more nucleic acid molecules of the test sample to the labeled probes, so as to form a modified solid surface, wherein each of the one or more nucleic acid molecules of the test sample is labeled with a second detectable label material;

(c) scanning the modified solid surface to detect the first detectable label material and to thereafter generate first data associated with each labeled probe set, wherein the first data associated with each labeled probe set is indicative of a quantity of labeled probes of that labeled probe set;

(d) scanning the modified solid surface to detect the second detectable label material and to thereafter generate second data associated with each labeled probe set, wherein the second data associated with each labeled probe set is indicative of a quantity of one or more nucleic acid sequences in the nucleic acid molecules of the test sample; and

(e) mathematically transforming the first data and the second data so as to determine the copy number of one or more nucleic acid sequences in the test sample relative to the copy number of the one or more different nucleic acid sequences in the test sample or the reference genome.

### Embodiment 2

The method of embodiment 1,

wherein mathematically transforming the first data and the second data includes:

determining a plurality of ratio values, wherein each ratio value is based on at least one data value of the first data and at least one data value of the second data, and wherein the at least one data value of the first data and the at least one data value of the second data are associated with a common location on the modified solid surface; and

transforming the plurality of ratio values from a linear space to a log space.

### Embodiment 3

The method of embodiment 1,

wherein mathematically transforming the first data and the second data includes:

compensating the first data for additive spatial bias so as to generate compensated first data associated with each labeled probe set;

compensating the second data for additive spatial bias so as to generate compensated second data associated with each labeled probe set;

determining a first plurality of log ratio values, wherein each log ratio value of the first plurality of log ratio values is based on (i) the compensated first data associated with each labeled probe set, and (ii) the compensated second data associated with each labeled probe set; and

determining a second plurality of log ratio values by compensating the first plurality of log ratio values for multiplicative spatial bias.

### Embodiment 4

The method of embodiment 1,

wherein the first data associated with each labeled probe set comprises a respective first plurality of data values,

wherein the second data associated with each labeled probe set comprises a respective second plurality of data values, and

wherein mathematically transforming the first data and the second data includes:

for each of the labeled probe sets of the plurality of labeled probe sets:

(i) for each data value of a given first plurality of data values associated with a given labeled probe set, determining an additive spatial bias value and subtracting the additive spatial bias value from the data value so as to generate a compensated data value based on the data value of the given first plurality of data values,

(ii) for each data value of a given second plurality of data values associated with the given labeled probe set, determining an additive spatial bias value and subtracting the additive spatial bias value from the data value so as to generate a compensated data value based on the given second plurality of data values,

(iii) maintaining third data that comprises each of the compensated data values based on the given first plurality of data values; and

(iv) maintaining fourth data that comprises each of the compensated data values based on the given second plurality of data values.

### Embodiment 5

The method of embodiment 4,

wherein each data value of the first data is associated with a respective data value of the second data, the third data, and the fourth data,

wherein each data value of the first data and the respective data value of the second data, the third data, and the fourth data are associated with a respective location at the modified solid surface,

wherein each data value of the first data is indicative of the quantity of labeled probes bound to the modified solid surface location that is associated with the data value, and

wherein each data value of the second data is indicative of the quantity of labeled nucleic acid molecules of the test sample hybridized to the labeled probes bound to the modified solid surface location that is associated with the data value.

### Embodiment 6

The method of embodiment 4,
wherein determining the additive spatial bias value for each data value of the given first plurality of data values associated with a given labeled probe set includes passing the data value through a filter, and
wherein determining the additive spatial bias value for each data value of the given second plurality of data values associated with the given labeled probe set includes passing the data value through the filter.

### Embodiment 7

The method of embodiment 6, wherein the filter comprises a two-dimensional sliding window median or mean smoother.

### Embodiment 8

The method of embodiment 4,
wherein mathematically transforming the first data and the second data further includes:

determining a first plurality of log ratio values based on a compensated data value of the third data (CDV3) and a corresponding compensated data value of the fourth data (CDV4).

### Embodiment 9

The method of embodiment 8, wherein each log ratio value of the first plurality of log ratio values is equal to log₂ (the CDV4 divided by the corresponding CDV3).

### Embodiment 10

The method of embodiment 8,

wherein mathematically transforming the first data and the second data further includes:

determining a second plurality of log ratio values by, for each log ratio value of the first plurality of log ratio values, determining a multiplicative bias value associated with the log ratio value, and subtracting the multiplicative bias value from the associated log ratio value so as to generate a log ratio value compensated for multiplicative bias.

### Embodiment 11

The method of embodiment 10, wherein determining the multiplicative bias value associated with the log ratio value, for each log ratio value of the first plurality of log ratio values, includes passing the first plurality of log ratio values through a filter.

### Embodiment 12

The method of embodiment 11, wherein the filter is selected from the group consisting of: (i) a one-dimensional sliding window median smoother filter, (ii) a two-dimensional sliding window median smoother filter, (iii) a one-dimensional loess filter, (iv) a two-dimensional loess filter, (v) a one-dimensional spline filter, (vi) a two-dimensional spline filter, (vii) a one-dimensional k-nearest neighbor smoother, and (viii) a two-dimensional k-nearest neighbor smoother.

### Embodiment 13

The method of embodiment 10,

wherein mathematically transforming the first data and the second data further includes:

determining a third plurality of log ratio values by, for each log ratio value of the second plurality of log ratio values, determining a probe sequence bias value associated with the log ratio value, and subtracting the probe sequence bias value from the associated log ratio value so as to generate a log ratio value compensated for probe sequence bias.

### Embodiment 14

The method of embodiment 13, wherein the determining each of the probe sequence bias values associated with the log ratio values includes passing the second plurality of log ratio values through a filter.

### Embodiment 15

The method of embodiment 14, wherein the filter comprises a filter selected from the group consisting of: (i) a median filter, and (ii) a one-dimensional sliding window median smoothing filter.

### Embodiment 16

The method of embodiment 13, wherein the probe sequence bias comprises guanine/cytosine (GC) content bias.

### Embodiment 17

The method of embodiment 13, wherein mathematically transforming the first data and the second data further includes:

determining a fourth plurality of log ratio values by, for each log ratio value of the third plurality of log ratio values, determining a historical bias value associated with the log ratio value, and subtracting the historical bias value from the associated log ratio value so as to generate a log ratio value compensated for historical bias.

### Embodiment 18

The method of embodiment 17, wherein determining the historical bias value associated with the log ratio value includes determining an average log ratio value over a set of historical measurements.

### Embodiment 19

The method of embodiment 18, wherein each historical bias value is associated with a reference genome.

### Embodiment 20

The method of embodiment 1, wherein the first detectable label material is directly attached to the one or more probes of each labeled probe set or is indirectly attached to the one or more probes of each labeled probe set.

### Embodiment 21

The method of embodiment 1, wherein the solid surface is selected from the group consisting of (i) a flexible solid surface, (ii) a nylon membrane, (iii) a rigid solid surface, (iv) a glass slide, and (v) a three-dimensional matrix.

### Embodiment 22

The method of embodiment 21,

wherein the solid surface comprises a glass slide or a three-dimensional matrix, and

wherein the plurality of labeled probe sets bound to the solid surface are contact printed onto the glass slide or onto the three dimensional matrix.

### Embodiment 23

The method of embodiment 1,

wherein the labeled probes sets including one or more probes labeled with the first detectable label material and the one or more nucleic acid molecules labeled with the second detectable label material are separately detectable.

### Embodiment 24

The method of embodiment 1, wherein providing the solid surface including the plurality of labeled probe sets bound to the solid surface includes (i) constructing onto the solid surface probes that are not labeled with the first detectable label material, and thereafter, hybridizing the first detectable label material to the probes constructed onto the solid surface, or (ii) constructing probes onto the solid surface, wherein the probes are labeled with the first detectable label material prior to constructing the probes onto the solid surface.

### Embodiment 25

The method of embodiment 1, wherein providing the solid surface including the plurality of labeled probe sets bound to the solid surface comprises:

providing a solid surface including a plurality of unlabeled probe sets bound to the solid surface;

contacting the solid surface with a plurality of nucleic acid molecules from a reference collection, wherein the plurality of nucleic acid molecules from the reference collection are labeled with the first detectable label material, and wherein the plurality of nucleic acid molecules from the reference collection contains a known copy number of the plurality of nucleic acid molecules; and

hybridizing the labeled plurality of nucleic acid molecules from the reference collection to probe material on the solid surface.

### Embodiment 26

The method of embodiment 25, wherein the plurality of nucleic acid molecules from the reference collection comprises a plurality of synthetic oligonucleotides.

### Embodiment 27

The method of embodiment 25, wherein the plurality of nucleic acid molecules from the reference collection comprises DNA from one or more normal reference genomes.

### Embodiment 28

The method of embodiment 25, wherein at least one of the labeled probe sets bound to the solid surface comprises molecules selected from the group consisting of (i) a negative control, and (ii) a positive control.

### Embodiment 29

The method of embodiment 25,

wherein a number of the labeled probe sets bound to the solid surface comprise molecules selected from a positive control,

wherein each labeled probe set of the number of labeled probe sets is diluted to a different concentration, and

wherein the number of differently diluted labeled probe sets is used to inform correction of bias in the first data and the second data, the bias associated with concentration of the labeled probe sets.

### Embodiment 30

The method of embodiment 25, wherein hybridizing the labeled plurality of nucleic acid molecules from the reference collection to the probe material is irreversible.

### Embodiment 31

The method of embodiment 25, wherein the copy number of the plurality of nucleic acid molecules from the reference collection is perturbed by flow sorting or by adding genomic DNA.

### Embodiment 32

The method of embodiment 25,

wherein the labeled probes sets labeled with the first detectable label material and the one or more nucleic acid molecules labeled with the second detectable label material are separately detectable.

### Embodiment 33

The method of embodiment 1, wherein each labeled probe set of the plurality of labeled probe sets is immobilized separately on a respective individual surface of the solid surface.

### Embodiment 34

The method of embodiment 33, wherein each individual surface comprises a respective plurality of beads.

### Embodiment 35

The method of embodiment 1, wherein each of the one or more probes labeled with a first detectable label material is derived from cloned DNA selected from the group consisting of (i) bacterial artificial chromosome clones, and (ii) P1-derived artificial chromosomes.

### Embodiment 36

The method of embodiment 1, wherein each of the one or more labeled probes is selected from the group consisting of (i) oligonucleotides synthesized in situ, and (ii) oligonucleotides synthesized and then arrayed ex situ.

### Embodiment 37

The method of embodiment 1, wherein mathematically transforming the first data and the second data so as to determine the copy number of the one or more nucleic acid sequences includes using probe sequence data to correct sequence-related bias.

### Embodiment 38

The method of 37, wherein the probe sequence data indicates a fractional guanine/cytosine (GC) nucleotide base content of the one or more nucleic acid molecules of the test sample.

### Embodiment 39

The method of 37, wherein the probe sequence data indicates a repetitive sequence content of the one or more nucleic acid molecules of the test sample.

### Embodiment 40

The method of embodiment 1, wherein the quantity of labeled probes of each labeled probe set is indicative of a corresponding copy number of the reference genome.

### Embodiment 41

The method of embodiment 1, further comprising:

(f) at a display, visually presenting an image of the determined copy number of at least one of the nucleic acid sequences in the test sample relative to the respective copy number of at least one different nucleic acid sequence in the test sample or of the reference genome.

### Embodiment 42

The method of embodiment 1,

wherein the first data generated in response to scanning the modified solid surface comprises pixel data associated with a first image of the modified solid surface, and

wherein the second data generated in response to scanning the modified solid surface comprises pixel data associated with a second image of the modified solid surface.

### Embodiment 43

The method of embodiment 42, further comprising:

combining the first data and the second data to generate third data, wherein the third data comprises pixel data for producing a third image that represents the first image combined with the second image, and

at a display, displaying at least one of the first image, the second image, and the third image.

### Embodiment 44

A system to determined a respective copy number of one or more nucleic acid sequences in a test sample relative to a respective copy number of one or more different nucleic acid sequences in the test sample or of a reference genome, the test sample including one or more nucleic acid molecules, the system comprising:

(a) a scanner to:
(i) scan a modified solid surface to detect a first detectable label material and to thereafter generate first data associated with each labeled probe set of a plurality of labeled probe sets bound to the modified solid surface,
wherein each of the labeled probe sets includes one or more probes labeled with the first detectable label material,
wherein each probe is representative of a nucleic acid sequence, and
wherein the first data associated with each labeled probe set is indicative of a quantity of labeled probes of that labeled probe set, and
(ii) scan the modified solid surface to detect a second detectable label material and to thereafter generate second data associated with each labeled probe set,
wherein each of the one or more nucleic acid molecules of the test sample is labeled with the second detectable label material,
wherein the second data associated with each labeled probe set is indicative of a quantity of one or more nucleic acid sequences in the nucleic acid molecules of the test sample, and
wherein formation of the modified solid surface includes contacting the one or more labeled probes with the one or more nucleic acid molecules of the test sample under conditions suitable for hybridizing the one or more nucleic acid molecules of the test sample to the labeled probes,

(b) a processor; and

(c) data storage containing computer-readable program instructions executable by the processor, wherein the program instructions include instructions executable by the processor to mathematically transform the first data and the second data so as to determine the copy number of one or more nucleic acid sequences in the test sample relative to the copy number of the one or more different nucleic acid sequences in the test sample or the reference genome.

### Embodiment 45

The system of embodiment 44, further comprising:

(d) a display to visually present an image of the determined copy number of each of the one or more nucleic acid sequences in the test sample relative to the copy number of the one or more different nucleic acid sequences in the test sample or the reference genome,

wherein the program instructions include instructions executable by the processor to generate the image from the determined copy number of each of the one or more nucleic acid sequences in the test sample relative to the copy number of the one or more different nucleic acid sequences in the test sample or the reference genome.

### Embodiment 46

The system of embodiment 44, further comprising:

(d) a communication means to output a printable report that identifies the determined copy number of each of the one or more nucleic acid sequences in the test sample relative to the copy number of the one or more different nucleic acid sequences in the test sample or the reference genome,

wherein the program instructions include instructions executable by the processor to generate the printable report that identifies the determined copy number of each of the one or more nucleic acid sequences in the test sample relative to the copy number of the one or more different nucleic acid sequences in the test sample or the reference genome.

### Embodiment 47

The system of embodiment 44, wherein the instructions executable by the processor to mathematically transform the first data and the second data comprise instructions to:

(i) compensate the first data for additive spatial bias so as to generate compensated first data associated with each labeled probe set,

(ii) compensate the second data for additive spatial bias so as to generate compensated second data associated with each labeled probe set,

(iii) determine a first plurality of log ratio values, wherein each log ratio value of the first plurality of log ratio values is based on the compensated first data associated with each labeled probe set and the compensated second data associated with each labeled probe set, and

(iv) determine a second plurality of log ratio values by compensating the first plurality of log ratio values for multiplicative spatial bias.

### Embodiment 48

A method for determining a copy number of one or more nucleic acid molecules of a test sample relative to a corresponding copy number of a reference genome, the method comprising:

(a) providing a solid surface including a plurality of labeled probe sets bound to the solid surface, wherein each of the labeled probe sets includes one or more probes labeled with a first detectable label material;

(b) scanning the solid surface to obtain first data associated with each labeled probe set, wherein the first data associated with each labeled probe set is indicative of a quantity of labeled probes of that labeled probe set;

(c) contacting the labeled probes on the solid surface with the one or more nucleic acid molecules of the test sample, under conditions suitable for hybridizing the one or more nucleic acid molecules of the test sample to the labeled probes, so as to from a modified solid surface, wherein each of the one or more nucleic acid molecules of the test sample is labeled with a second detectable label material;

(d) scanning the modified solid surface to obtain second data associated with each labeled probe set, wherein the second data associated with each labeled probe set is indicative of the quantity of labeled probes of that labeled probe set plus a quantity of the labeled nucleic acid molecules of the test sample hybridized to the labeled probes of that labeled probe set; and

(e) mathematically transforming the first data and the second data so as to determine the copy number of each of the one or more nucleic acid molecules relative to the corresponding copy number of the reference genome.

### Embodiment 49

The method of embodiment 48,

wherein the first detectable label material and the second detectable label material are the same detectable label material, and

wherein the probes sets labeled with the first detectable label material and the one or more nucleic acid molecules labeled with the second label material are detectable in a single channel.

We claim:

1. A method for determining a respective copy number of one or more nucleic acid sequences in a test sample relative to a respective copy number of one or more different nucleic acid sequences in the test sample or of a reference genome, the test sample including one or more nucleic acid molecules, the method comprising:
(a) providing a solid surface including a plurality of labeled probe sets bound to the solid surface, wherein each of the labeled probe sets includes one or more probes labeled with a first detectable label material, and wherein each probe is representative of a nucleic acid sequence;
(b) contacting the labeled probes on the solid surface with the one or more nucleic acid molecules of the test sample, under conditions suitable for hybridizing the one or more nucleic acid molecules of the test sample to the labeled probes, so as to form a modified solid surface, wherein each of the one or more nucleic acid molecules of the test sample is labeled with a second detectable label material;
(c) scanning the modified solid surface to detect the first detectable label material and to thereafter generate first data associated with each labeled probe set, wherein the first data associated with each labeled probe set is indicative of a quantity of labeled probes of that labeled probe set;
(d) scanning the modified solid surface to detect the second detectable label material and to thereafter generate second data associated with each labeled probe set, wherein the second data associated with each labeled probe set is indicative of a quantity of one or more nucleic acid sequences in the nucleic acid molecules of the test sample; and
(e) mathematically transforming the first data and the second data so as to determine the copy number of one or more nucleic acid sequences in the test sample relative to the copy number of the one or more different nucleic acid sequences in the test sample or the reference genome.

2. The method of claim 1,
wherein mathematically transforming the first data and the second data includes:
determining a plurality of ratio values, wherein each ratio value is based on at least one data value of the first data and at least one data value of the second data, and wherein the at least one data value of the first data and the at least one data value of the second data are associated with a common location on the modified solid surface; and
transforming the plurality of ratio values from a linear space to a log space.

3. The method of claim 1,
wherein mathematically transforming the first data and the second data includes:
compensating the first data for additive spatial bias so as to generate compensated first data associated with each labeled probe set;
compensating the second data for additive spatial bias so as to generate compensated second data associated with each labeled probe set;
determining a first plurality of log ratio values, wherein each log ratio value of the first plurality of log ratio values is based on (i) the compensated first data associated with each labeled probe set, and (ii) the compensated second data associated with each labeled probe set; and
determining a second plurality of log ratio values by compensating the first plurality of log ratio values for multiplicative spatial bias.

4. The method of claim 1,
wherein the first data associated with each labeled probe set comprises a respective first plurality of data values,
wherein the second data associated with each labeled probe set comprises a respective second plurality of data values, and
wherein mathematically transforming the first data and the second data includes:
for each of the labeled probe sets of the plurality of labeled probe sets:
(i) for each data value of a given first plurality of data values associated with a given labeled probe set, determining an additive spatial bias value and subtracting the additive spatial bias value from the data value so as to generate a compensated data value based on the data value of the given first plurality of data values,
(ii) for each data value of a given second plurality of data values associated with the given labeled probe set, determining an additive spatial bias value and subtracting the additive spatial bias value from the data value so as to generate a compensated data value based on the given second plurality of data values,
(iii) maintaining third data that comprises each of the compensated data values based on the given first plurality of data values; and
(iv) maintaining fourth data that comprises each of the compensated data values based on the given second plurality of data values.

5. The method of claim 4,
wherein each data value of the first data is associated with a respective data value of the second data, the third data, and the fourth data,
wherein each data value of the first data and the respective data value of the second data, the third data, and the fourth data are associated with a respective location at the modified solid surface,
wherein each data value of the first data is indicative of the quantity of labeled probes bound to the modified solid surface location that is associated with the data value, and
wherein each data value of the second data is indicative of the quantity of labeled nucleic acid molecules of the test sample hybridized to the labeled probes bound to the modified solid surface location that is associated with the data value.

6. The method of claim 4,
wherein determining the additive spatial bias value for each data value of the given first plurality of data values associated with a given labeled probe set includes passing the data value through a filter, and
wherein determining the additive spatial bias value for each data value of the given second plurality of data values associated with the given labeled probe set includes passing the data value through the filter.

7. The method of claim 4,
wherein mathematically transforming the first data and the second data further includes:
determining a first plurality of log ratio values based on a compensated data value of the third data (CDV3) and a corresponding compensated data value of the fourth data (CDV4).

8. The method of claim 7,
wherein mathematically transforming the first data and the second data further includes:
determining a second plurality of log ratio values by, for each log ratio value of the first plurality of log ratio values, determining a multiplicative bias value associated with the log ratio value, and subtracting the multiplicative bias value from the associated log ratio value so as to generate a log ratio value compensated for multiplicative bias.

9. The method of claim 1, wherein the first detectable label material is directly attached to the one or more probes of each labeled probe set or is indirectly attached to the one or more probes of each labeled probe set.

10. The method of claim 1,
wherein the labeled probes sets including one or more probes labeled with the first detectable label material and the one or more nucleic acid molecules labeled with the second detectable label material are separately detectable.

11. The method of claim 1, wherein providing the solid surface including the plurality of labeled probe sets bound to the solid surface includes (i) constructing onto the solid surface probes that are not labeled with the first detectable label material, and thereafter, hybridizing the first detectable label material to the probes constructed onto the solid surface, or (ii) constructing probes onto the solid surface, wherein the probes are labeled with the first detectable label material prior to constructing the probes onto the solid surface.

12. The method of claim 1, wherein providing the solid surface including the plurality of labeled probe sets bound to the solid surface comprises:
providing a solid surface including a plurality of unlabeled probe sets bound to the solid surface;
contacting the solid surface with a plurality of nucleic acid molecules from a reference collection, wherein the plurality of nucleic acid molecules from the reference collection are labeled with the first detectable label material, and wherein the plurality of nucleic acid molecules from the reference collection contains a known copy number of the plurality of nucleic acid molecules; and
hybridizing the labeled plurality of nucleic acid molecules from the reference collection to probe material on the solid surface.

13. The method of claim 1, wherein the quantity of labeled probes of each labeled probe set is indicative of a corresponding copy number of the reference genome.

14. The method of claim 1, further comprising:
(f) at a display, visually presenting an image of the determined copy number of at least one of the nucleic acid sequences in the test sample relative to the respective copy number of at least one different nucleic acid sequence in the test sample or of the reference genome.

15. A system to determine a respective copy number of one or more nucleic acid sequences in a test sample relative to a respective copy number of one or more different nucleic acid sequences in the test sample or of a reference genome, the test sample including one or more nucleic acid molecules, the system comprising:
(a) a scanner to:
(i) scan a modified solid surface to detect a first detectable label material and to thereafter generate first data associated with each labeled probe set of a plurality of labeled probe sets bound to the modified solid surface,
wherein each of the labeled probe sets includes one or more probes labeled with the first detectable label material,
wherein each probe is representative of a nucleic acid sequence, and
wherein the first data associated with each labeled probe set is indicative of a quantity of labeled probes of that labeled probe set, and
(ii) scan the modified solid surface to detect a second detectable label material and to thereafter generate second data associated with each labeled probe set,
wherein each of the one or more nucleic acid molecules of the test sample is labeled with the second detectable label material,
wherein the second data associated with each labeled probe set is indicative of a quantity of one or more nucleic acid sequences in the nucleic acid molecules of the test sample, and
wherein formation of the modified solid surface includes contacting the one or more labeled probes with the one or more nucleic acid molecules of the test sample under conditions suitable for hybridizing the one or more nucleic acid molecules of the test sample to the labeled probes,
(b) a processor; and
(c) data storage containing computer-readable program instructions executable by the processor, wherein the program instructions include instructions executable by the processor to mathematically transform the first data and the second data so as to determine the copy number of one or more nucleic acid sequences in the test sample relative to the copy number of the one or more different nucleic acid sequences in the test sample or the reference genome.

16. The system of claim 15, further comprising:
(d) a display to visually present an image of the determined copy number of each of the one or more nucleic acid sequences in the test sample relative to the copy number of the one or more different nucleic acid sequences in the test sample or the reference genome,
wherein the program instructions include instructions executable by the processor to generate the image from the determined copy number of each of the one or more nucleic acid sequences in the test sample relative to the copy number of the one or more different nucleic acid sequences in the test sample or the reference genome.

17. The system of claim 15, further comprising:
(d) a communication means to output a printable report that identifies the determined copy number of each of the one or more nucleic acid sequences in the test sample relative to the copy number of the one or more different nucleic acid sequences in the test sample or the reference genome,
wherein the program instructions include instructions executable by the processor to generate the printable report that identifies the determined copy number of each of the one or more nucleic acid sequences in the test sample relative to the copy number of the one or more different nucleic acid sequences in the test sample or the reference genome.

18. The system of claim 15, wherein the instructions executable by the processor to mathematically transform the first data and the second data comprise instructions to:
(i) compensate the first data for additive spatial bias so as to generate compensated first data associated with each labeled probe set,
(ii) compensate the second data for additive spatial bias so as to generate compensated second data associated with each labeled probe set,
(iii) determine a first plurality of log ratio values, wherein each log ratio value of the first plurality of log ratio values is based on the compensated first data associated with each labeled probe set and the compensated second data associated with each labeled probe set, and
(iv) determine a second plurality of log ratio values by compensating the first plurality of log ratio values for multiplicative spatial bias.

19. A method for determining a copy number of one or more nucleic acid molecules of a test sample relative to a corresponding copy number of a reference genome, the method comprising:
(a) providing a solid surface including a plurality of labeled probe sets bound to the solid surface, wherein each of the labeled probe sets includes one or more probes labeled with a first detectable label material;
(b) scanning the solid surface to obtain first data associated with each labeled probe set, wherein the first data associated with each labeled probe set is indicative of a quantity of labeled probes of that labeled probe set;
(c) contacting the labeled probes on the solid surface with the one or more nucleic acid molecules of the test sample, under conditions suitable for hybridizing the one or more nucleic acid molecules of the test sample to the labeled probes, so as to form a modified solid surface, wherein each of the one or more nucleic acid molecules of the test sample is labeled with a second detectable label material;
(d) scanning the modified solid surface to obtain second data associated with each labeled probe set, wherein the second data associated with each labeled probe set is indicative of the quantity of labeled probes of that labeled probe set plus a quantity of the labeled nucleic acid molecules of the test sample hybridized to the labeled probes of that labeled probe set; and
(e) mathematically transforming the first data and the second data so as to determine the copy number of each of the one or more nucleic acid molecules relative to the corresponding copy number of the reference genome.

20. The method of claim 19,
wherein the first detectable label material and the second detectable label material are the same detectable label material, and
wherein the probes sets labeled with the first detectable label material and the one or more nucleic acid molecules labeled with the second label material are detectable in a single channel.
